(19) United States
(12) Patent Application Publication
(10) Pub. No.: US 2016/0179355 A1
(43) Pub. Date: Jun. 23, 2016

(54) SYSTEM AND METHOD FOR MANAGING IMAGE SCAN PARAMETERS IN MEDICAL IMAGING

(71) Applicant: General Electric Company, Schenectady, NY (US)

(72) Inventor: Swetha K S, Bangalore (IN)

(21) Appl. No.: 14/712,365

(22) Filed: May 14, 2015

(30) Foreign Application Priority Data
Dec. 23, 2014 (IN) 6500/CHE/2014

(51) Int. Cl. G06F 3/0484; G06F 3/0488; G06T 7/00

(52) U.S. Cl. CPC G06F 3/04847; G06T 7/0012; G06F 3/0488; G06F 3/04845

(57) ABSTRACT

A system for managing touch based inputs is disclosed. The system includes a presentation unit capable of receiving touch based inputs and a processor for processing touch gestures received on the presentation unit. The rate of touch gestures determines a function to be performed.

### FIELD OF THE INVENTION

The subject matter disclosed herein relates to capturing medical images using a medical imaging apparatus. More specifically the subject matter relates to managing image scan parameters associated with different medical images in a medical imaging apparatus.

### BACKGROUND OF THE INVENTION

Nowadays touch based user interface is common in all devices used in fields varying from consumer products to healthcare related products. Mobile devices such as smart phones used by users have touch based user interface and all operations in the devices are performed based on touch inputs received from the user. Numerous healthcare devices also have touch based user interface, and an ultrasound imaging device is such a device that may have a touch based user interface. The ultrasound imaging device may be a portable tablet device or mobile device having an ultrasound probe. The ultrasound probe is used for capturing medical images from the patient that are presented in the user interface of the ultrasound imaging device. The user may need to do measurements in a medical image and different touch inputs can be given to perform measurements.

The ultrasound imaging device is used to for scanning at different modes. The modes depend on the body portion of the patient that needs to be scanned. Thus the modes may include a cardiac scanning mode, an obstetric mode, an abdomen scanning mode and so on. For each mode there may be multiple image scan parameters that need to be varied or new image scan parameters may be present. The user may need to make many configuration changes to vary the image scan parameters and configure appropriate mode. The user interface (UI) of the ultrasound imaging device presents multiple UI elements that need to be accessed for changing the mode and image scanning parameters. Accessing multiple UI elements is more difficult and time consuming when different modes need to be configured and various image scan parameters need to be selected. When the ultrasound imaging apparatus is a hand held device then accessing the UI elements by touch inputs may be difficult.

Accordingly, a need exists for an improved system and method for managing image scan parameters is required.

### SUMMARY OF THE INVENTION

The object of the invention is to provide an improved system and method for managing image scan parameters as defined in the independent claim. This is achieved by the system that enables the user to provide tap gestures in one or more regions on a presentation unit i.e. a display screen for changing image scan parameters.

One advantage with the disclosed system is that it provides an improved way of managing image scan parameters for medical imaging. In the present system no separate UI elements presented in the display screen for accessing and modifying the image scan parameters. For instance one or more side end portions of the display screen are used to provide tap gestures by the user for varying the image scan parameters.

In an embodiment a system for managing touch based inputs is disclosed. The system includes a presentation unit capable of receiving touch based inputs and a processor for processing touch gestures received on the presentation unit. The rate of touch gestures determines a function to be performed.

In another embodiment a method for managing image scan parameters in a medical imaging device. The method involves presenting medical images through a presentation unit of a device; and receiving touch gestures through the presentation unit, wherein a rate of touch gestures determines a function associated with the medical images to be performed.

A more complete understanding of the present invention, as well as further features and advantages thereof, will be obtained by reference to the following detailed description and drawings.

### BRIEF DESCRIPTION OF THE DRAWINGS

FIG. 1 illustrates an information input and control system in which the inventive arrangements can be practiced;

FIG. 2 illustrates a system for processing touch based user inputs according to an embodiment;

FIG. 3 schematic illustration of a portable medical imaging device such as an ultrasound imaging system according to an embodiment;

FIG. 4 is a schematic illustrations of a medical imaging device having a user interface according to an embodiment;

FIG. 5 illustrates the user interface presenting image cine according to an embodiment; and

FIG. 6 illustrates a flow diagram of a method for processing touch based inputs according to an embodiment.

### DETAILED DESCRIPTION OF THE INVENTION

In the following detailed description, reference is made to the accompanying drawings that form a part hereof, and in which is shown by way of illustration specific embodiments that may be practiced. These embodiments are described in sufficient detail to enable those skilled in the art to practice the embodiments, and it is to be understood that other embodiments may be utilized and that logical, mechanical and other changes may be made without departing from the scope of the embodiments. The following detailed description is, therefore, not to be taken as limiting the scope of the invention.

As discussed in detail below, embodiments of an apparatus for managing touch inputs from a user is disclosed. The apparatus comprises a user interface configured as a touch sensitive display and capable of receiving touch inputs. The touch input processor is configured to process touch inputs associated to a function in one or more first regions of the user interface and perform operations in a second region of the user interface to execute the function.

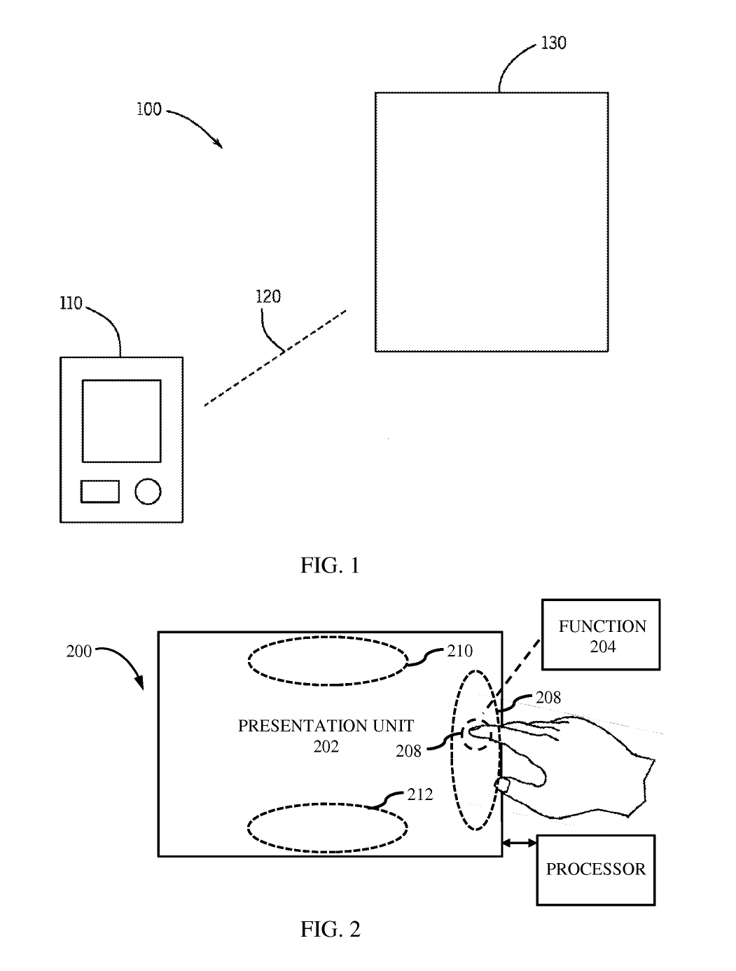

FIG. 1 illustrates an information input and control system 100 in which the inventive arrangements can be practiced. More specifically, the system 100 includes an interface 110, communication link 120, and application 130. The components of the system 100 can be implemented in software, hardware, and/or firmware, as well as in various combinations thereof and the like, as well as implemented separately and/or integrated in various forms, as needed and/or desired.

The communication link 120 connects the interface 110 and application 130. Accordingly, it can be a cable link or wireless link. For example, the communication link 120 could include one or more of a USB cable connection or other cable connection, a data bus, an infrared link, a wireless link, such as Bluetooth, WiFi, 802.11, and/or other data connections, whether cable, wireless, or other. The interface 110 and communication link 120 can allow a user to input and retrieve information from the application 130, as well as to execute functions at the application 130 and/or other remote systems (not shown).

Preferably, the interface 110 includes a touch based user interface, such as a graphical user interface, that allows a user to input information, retrieve information, activate application functionality, and/or otherwise interact with the application 130. The touch based user interface may include, for example, a tablet-based interface which is touch based capable of accepting stylus, pen, and/or other human touch and/or human-directed inputs. As such, the interface 110 may be used to drive the application 130 and serve as an interaction device to display and/or view and/or interact with various screen elements, such as patient images and/or other information. Preferably, the interface 110 may execute on, and/or be integrated with, a computing device, such as a tablet-based computer, a personal digital assistant, a pocket PC, a laptop, a notebook computer, a desktop computer, a cellular phone, a smart phone and/or other computing systems. As such, the interface 110 preferably facilitates wired and/or wireless communication with the application 130 and provides one or more of audio, video, and/or other graphical inputs, outputs, and the like.

A preferred application 130 may be a healthcare software application, such as an image/data viewing application, an image/data analysis application, an ultrasound imaging application, and/or other patient and/or practice management applications. In such an embodiment, the application 130 may include hardware, such as a PACS workstation, advantage workstation (“AW”), PACS server, image viewer, personal computer, workstation, server, patient monitoring system, imaging system, and/or other data storage and/or processing devices, for example. The interface 110 may be used to manipulate functionality at the application 130 including, but not limited to, for example, an image zoom (e.g., single or multiple zooms), application and/or image resets, display window/level settings, cines/motions, magic glasses (e.g., zoom eyeglasses), image/document annotations, image/document rotations (e.g., rotate left, right, up, down, etc.), image/document flipping (e.g., flip left, right, up, down, etc.), undo, redo, save, close, open, print, pause, indicate significance, etc. Images and/or other information displayed at the application 130 may be affected by the interface 110 via a variety of operations, such as touch gesture, glide gesture, pan, cine forward, cine backward, pause, print, window/level, etc.

The interface 110 and communication link 120 may also include multiple levels of data transfer protocols and data transfer functionality. They may support one or more system-level profiles for data transfer, such as an audio/video remote control profile, a cordless telephony profile, an intercom profile, an audio/video distribution profile, a headset profile, a hands-free profile, a file transfer protocol, a file transfer profile, an imaging profile, and/or the like. The interface 110 and communication link 120 may be used to support data transmission in a personal area network (PAN) and/or other network.

FIG. 2 illustrates a system 200 for processing touch based user inputs according to an embodiment. The system 200 includes a presentation unit 202 that presents multiple user interface elements or any other content. The presentation unit 202 may be a touch based user interface or a touch based display screen according to an embodiment. The presentation unit 202 is configured to receive touch inputs from a user. The touch inputs may include but not limited to, tap gestures. A rate of tap gesture determines a function (example a function 204) to be performed. The tap gestures are processed by a processor 206 for performing the function 204. The rate of touch gestures may refer to a speed of tapping on the presentation unit 202 using the user's finger. Based on the speed of the tapping the function to be performed by the system 200 is varied or changed. The tapping gesture may be provided on any region of the presentation unit 202. The region may be a side end portion 208 of the presentation unit 202 as shown in FIG. 2. The side end portion 208 is part of an image area of the presentation unit 202. More particularly the tapping gesture may be provided at a point 209 within the side end portion 208. The side end portion 208 is shown as an exemplary region where the tapping gesture can be provided however it may be envisioned that different regions on the presentation unit 202 may be associated to different functions to be performed by the system 200 according to other embodiments. In another embodiment the rate of touch gestures may be a number of tapping gesture per unit time. For instance 4 taps per 5 seconds may determine a particular function to be performed or variation in a particular function to be performed.

Taking an example, the function to be performed may be for instance increasing and decreasing brightness of the presentation unit 202. The brightness can be increased by the user by tapping at high speed at a predefined portion of the presentation unit 202. The predefined portion may be for instance the side end portion 208 of the presentation unit 202. Whereas the brightness can be decreased by lowering the speed of tapping on the predefined portion. The tapping gesture for increasing and decreasing the brightness can be provided at different points within the predefined portion of the presentation unit 202. In another embodiment the tapping gesture of increasing the brightness can be provide at the side end portion of the presentation unit and whereas for decreasing the brightness the tapping gesture may be provided at a lower end portion of the presentation unit 202. Alternatively the tapping gestures for increasing and decreasing the brightness may be given in the same point within the predefined portion of the presentation unit 202.

In another example the function to be performed may be varying volume in the system 100. The volume can be increased by the user by tapping at high speed at a predefined portion such as a top side portion 210 of the presentation unit 202. Whereas the volume is decreased by the user by tapping at low speed at the top side portion 210. The tapping gesture for increasing and decreasing the volume can be provided at different points within the top side portion 210 of the presentation unit 202. In another embodiment the tapping gesture of increasing the volume can be provide at the top side portion 210 and whereas for decreasing the volume the tapping gesture may be provided at a lower end portion 212 of the presentation unit 202. Alternatively the tapping gestures for increasing and decreasing the volume may be given in the same point within the top side portion 210 of the presentation unit 202.

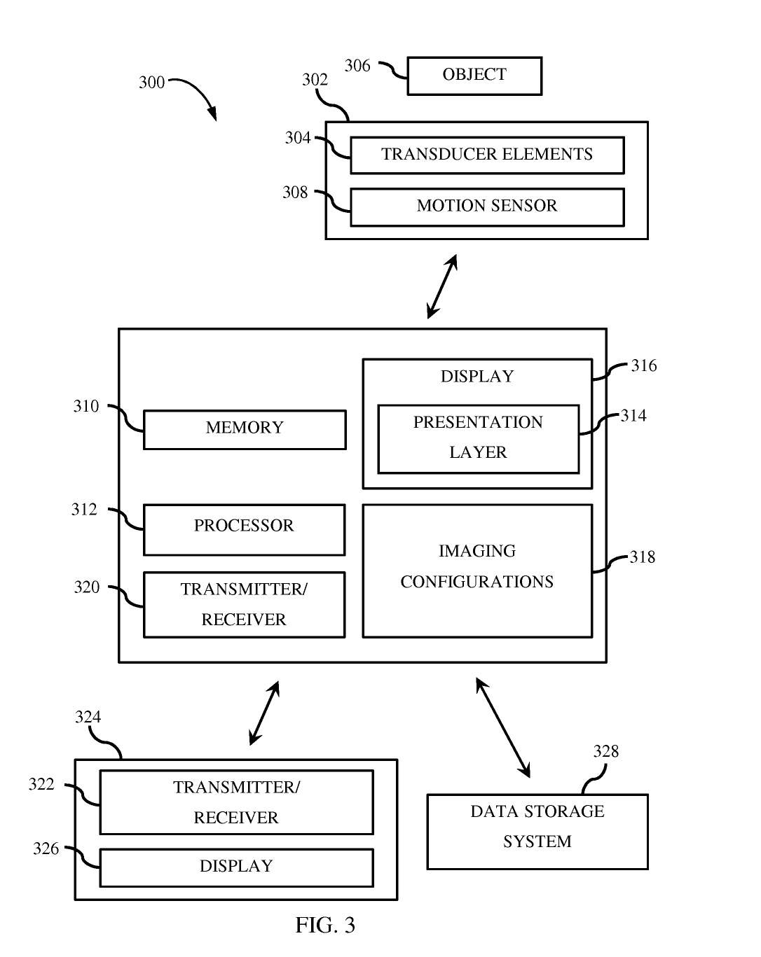

The system 200 may be embodied in a medical imaging device such as an ultrasound imaging system according to an exemplary embodiment. FIG. 3 is a schematic illustration of a portable medical imaging device such as an ultrasound imaging system 300. The ultrasound imaging system 300 may be a portable or a handheld ultrasound imaging system. For example, the ultrasound imaging system 300 may be similar in size to a smartphone, a personal digital assistant or a tablet. In other embodiments, the ultrasound imaging system 300 may be configured as a laptop or a cart based system. The ultrasound imaging system 300 may be transportable to a remote location, such as a nursing home, a medical facility, rural area, or the like. Further the ultrasound imaging system 300 may be moved from one imaging room to another in a particular location such as a medical facility. These imaging rooms may include but are not limited to a cardiac imaging room, an obstetric imaging room, and an emergency room.

A probe 302 is in communication with the ultrasound imaging system 300. The probe 302 may be mechanically coupled to the ultrasound imaging system 300. Alternatively, the probe 302 may wirelessly communicate with the ultrasound imaging system 300. The probe 302 includes transducer elements 304 that emit ultrasound pulses to an object 306 to be scanned, for example an organ of a patient. The ultrasound pulses may be back-scattered from structures within the object 306, such as blood cells or muscular tissue, to produce echoes that return to the transducer elements 304. The transducer elements 304 generate ultrasound image data based on the received echoes. The probe 302 also includes a motion sensor 308 in accordance with an embodiment. The motion sensor 308 may include but not limited to, an accelerometer, a magnetic sensor and a gyro sensor. The motion sensor 308 is configured to identify the position and orientation of the probe 302 on the object 306. The position and orientation may be identified in real-time, when a medical expert is manipulating the probe 302. The term “real-time” includes an operation or procedure that is performed without any intentional delay. The probe 302 transmits the ultrasound image data to the ultrasound imaging system 300. The ultrasound imaging system 300 includes a memory 310 that stores the ultrasound image data. The memory 310 may be a database, random access memory, or the like. In one embodiment, the memory 310 is a secure encrypted memory that requires a password or other credentials to access the image data stored therein. The memory 310 may have multiple levels of security. For example, a surgeon or doctor may have access to all of the data stored in the memory 310, whereas, a technician may have limited access to the data stored in the memory 310. In one embodiment, a patient may have access to the ultrasound image data related to the patient, but is restricted from all other data. A processor 312 accesses the ultrasound image data from the memory 310. The processor 312 may be a logic based device, such as one or more computer processors or microprocessors. The processor 312 generates an image based on the ultrasound image data. The image is displayed on a presentation layer 314, which may be, for example, a graphical user interface (GUI) or other displayed user interface, such as a virtual desktop. The presentation layer 314 may be a software based display that is accessible from multiple locations. The presentation layer 314 displays the image on a display 316 provided within the ultrasound imaging system 300. The display 316 may be a touch sensitive screen. Alternatively, the presentation layer 314 may be accessible through a web-based browser, local area network, or the like. In such an embodiment, the presentation layer 314 may be accessible remotely as a virtual desktop that displays the presentation layer 314 in the same manner as the presentation layer 314 is displayed in the display 316.

The ultrasound imaging system 300 includes imaging configurations 318 associated with different imaging procedures that can be performed. The imaging procedures include for example, obstetric imaging, cardiac imaging and abdominal imaging. Based on an imaging procedure to be performed a corresponding imaging configuration needs to be set. The imaging configuration may be set by a user in the ultrasound imaging system 300. The imaging configurations may be pre-stored in the ultrasound imaging system 300. The imaging configuration may include various image scan parameters (herein after referred as parameters) such as frequency, a speckle reduction imaging, time gain compensation, scan depth, scan format, image frame rate, field of view, focal point, scan lines per image frame, number of ultrasound beams and pitch of the transducer elements. These parameters vary for different imaging configurations. For example, the ultrasound imaging system 300 may be used for cardiac application by configuring a cardiac imaging configuration. Thereafter an abdominal imaging configuration stored in the ultrasound imaging system 300 needs to be set for performing the abdominal imaging application. For the cardiac application, an image frame rate is an important factor. Therefore the ultrasound imaging system 300 is set to switch off few imaging filters such as a frame averaging filter and a speckle reduction imaging filter, and also vary some parameters like narrow field of view, single focal point, lesser number of scan lines per image frame. Whereas for an abdominal application, resolution may be an important parameter. Thus the ultrasound imaging system 300 turns on medium or high frame averaging filter and a speckle reduction imaging filter. Further some parameters may be also set for example multiple focal points, wide field of view, more number of scan lines per image frame (i.e. higher line density), and transmission of multiple ultrasound beams.

The ultrasound imaging system 300 also includes a transmitter/receiver 320 that communicates with a transmitter/receiver 322 of a workstation 324. For example, the workstation 324 may be positioned at a location, such as a hospital, imaging center, or other medical facility. The workstation 324 may be a computer, tablet-type device, or the like. The workstation 324 may be any type of computer or end user device. The workstation 324 includes a display 326. The workstation 324 communicates with the ultrasound imaging system 300 to display an image based on image data acquired by the ultrasound imaging system 300 on the display 326. The workstation 324 also includes any suitable components image viewing, manipulation, etc.

The ultrasound imaging system 300 and the workstation 324 communicate through the transmitter/receivers 320 and 322, respectively. The ultrasound imaging system 300 and the workstation 324 may communicate over a local area network. For example, the ultrasound imaging system 300 and the workstation 324 may be positioned in separate remote locations of a medical facility and communicate over a network provided at the facility. In an exemplary embodiment, the ultrasound imaging system 300 and the workstation 324 communicate over an internet connection, such as through a web-based browser.

An operator may remotely access imaging data stored on the ultrasound imaging system 300 from the workstation 324. For example, the operator may log onto a virtual desktop or the like provided on the display 326 of the workstation 324. The virtual desktop remotely links to the presentation layer 314 of the ultrasound imaging system 300 to access the memory 310 of the ultrasound imaging system 300. The memory 310 may be secured and encrypted to limit access to the image data stored therein. The operator may input a password to gain access to at least some of the image data.

Once access to the memory 310 is obtained, the operator may select image data to view. It should be noted that the image data is not transferred to the workstation 324. Rather, the image data is processed by the processor 312 to generate an image on the presentation layer 314. For example, the processor 312 may generate a DICOM image on the presentation layer 314. The ultrasound imaging system 300 transmits the presentation layer 314 to the display 326 of the workstation 324 so that the presentation layer 314 is viewable on the display 326. In one embodiment, the workstation 324 may be used to manipulate the image on the presentation layer 314. The workstation 324 may be used to change an appearance of the image, such as rotate the image, enlarge the image, adjust the contrast of the image, or the like. Moreover, an image report may be input at the workstation 324. For example, an operator may input notes, analysis, and/or comments related to the image. In one embodiment, the operator may input landmarks or other notations on the image. The image report is then saved to the memory 310 of the ultrasound imaging system 300. Accordingly, the operator can access images remotely and provide analysis of the images without transferring the image data from the ultrasound imaging system 300. The image data remains stored only on the ultrasound imaging system 300 so that the data remains restricted only to individuals with proper certification.

In one embodiment, the ultrasound imaging system 300 is capable of simultaneous scanning and image data acquisition. The ultrasound imaging system 300 may be utilized to acquire a first set of imaging data, while a second set of imaging data is accessed to display on the display 326 of the workstation 324 an image based on the second set of imaging data. The ultrasound imaging system 300 may also capable of transferring the image data to a data storage system 328 present in a remote location. The ultrasound imaging system 300 communicates with the data storage system 328 over a wired or wireless network.

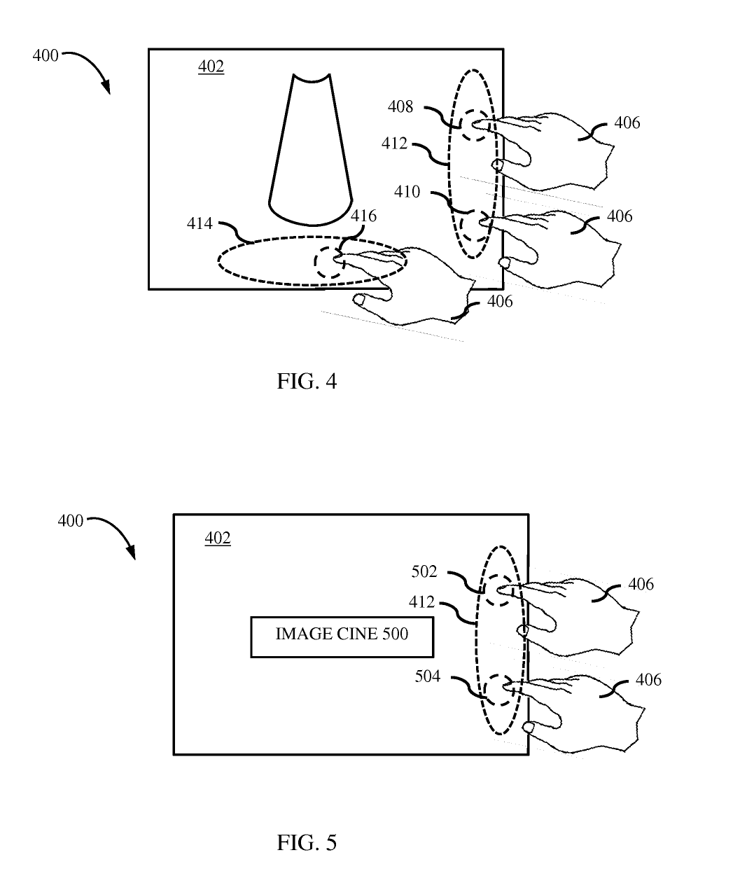

FIG. 4 illustrates a medical imaging device 400 having a user interface 402 according to an embodiment. The medical imaging device 400 may be an ultrasound imaging device. The ultrasound imaging device is configured to capture multiple ultrasound images of patient's body. The user interface 402 is a touch based user interface that can receive touch inputs from a user. As illustrated in FIG. 4 the user interface 402 presents an ultrasound image 404 captured from the patient. The user may be allowed to vary depth in the ultrasound image 404. For instance user's finger 406 is used to provide touch gestures at a region 408 for increasing the depth. The touch gestures may be tapping using the finger 406 in the region 408. The depth may be increased fast based on the speed of tapping using the finger 406. Further the user's finger 406 can be used to tap at a region 410 to decrease the depth. The depth may be decreased faster based on the speed of tapping using the finger 406. The regions 408 and 410 may be located within a right side end portion 412 of the user interface 402.

In another embodiment when tapping using the finger 406 is provided at the side end portion 412 at high speed, the depth is increased. Further when the finger is used to tap at low speed, then the depth is decreased. Even though the tapping gesture is provided in the side end portion 412 it may be envisioned that the tapping gestures can be input at different regions or locations such as but not limited to an upper end portion, a left side portion and so on, in the user interface 402. The depth may be configured before capturing the ultrasound image 404.

The user can also zoom in and out of the ultrasound image 404. The user may provide touch gestures at a lower end portion 414 of the user interface 402. In an embodiment the user may provide tap gestures at a region 416 to vary the zoom function. For instance when the tapping speed is increased the ultrasound image 404 may be zoomed in. Now when the tapping speed is decreased so that the ultrasound image 404 is zoomed out. A desired location within the ultrasound image 404 can be selected. This can be achieved by clicking the desired location using the user's finger 406. Once the desired location is selected the tapping gestures can be provided to zoom-in and zoom-out from the desired location. The zooming operation may be increased or decreased once the ultrasound image 404 is captured and stored. In another embodiment the desired location within the ultrasound image 404 may be selected by clicking on the desired location and tap gestures can be provided at the desired location for zooming in and zooming out. The process of zooming in and zooming out can be controlled by varying the rate of tap gestures provided in the desired location.

In another instance number of touch gestures such as tap gestures input per unit time varies a function in the ultrasound image 404. The function may be varying the depth and zoom function. When the number of tap gestures is more per unit time then the ultrasound image 404 is zoomed in. Whereas when the number of tap gestures is less per unit time then the ultrasound image 404 is zoomed out. Similarly the number of tap gestures per unit time can also vary the other function such as varying the depth associated with the ultrasound image 404. In an instance the number of tap gestures may be measured per second.

In an exemplary embodiment an indication may be presented in the user interface 402 as a guidance to identify the region 410 and the region 416 to the user for providing the tapping gestures. This is because the user using the medical imaging device may not know for varying a particular image scan parameter the location on the user interface 402 where the tap gestures need to be given. Hence such indication provides guidance to user to identify the location where the tap gestures need to be provided as input. The indication may be presented in the user interface 402 only for short time period so as to guide the user.

FIG. 5 illustrates the user interface 402 presenting image cine 500 according to an embodiment. The image cine 500 may be a combination of multiple image frames stored as a cine loop. The image cine 500 is captured and stored for reviewing at a later stage. Multiple such image cines may be captured and stored by the user for review and examination. While reviewing the image cine 500 then user may perform forwarding and rewinding operations to shuffle between image frames. The user's finger 406 can be used to provide tap gestures at a region 502 for forwarding the image cine 500. When speed of the tap gesture is increased then the image cine 500 is forwarded. Further when the tap gesture is provided at a region 504 then rewinding of the image cine 500 is performed. In an embodiment the tap speed at the region 504 is high then the image cine 500 is rewinded. In another embodiment the tap speed at the regions 502 and 504 determines the speed with which the forward and rewind operations in the image cine 500 are respectively performed. The region 502 and the region 504 are present within the side end portion 412 of the user interface 402. However it may be noted in other embodiments the region 502 and the region 504 may be in completely different locations in the user interface 402 and in some embodiments the region 504 and the region 502 may be combined in a single region and tap gestures in this region will result in forward and rewind operations in the image cine 500.

Multiple image cines are stored in the medical imaging device 400 and presented as a cine list. The image cines can be selected from the cine list by scrolling this list. The cine list is presented through the user interface 402. The scrolling of the cine list can also be performed in response to providing tap gestures in the user interface 402. The speed of the tap gestures determines the speed at which the cine list is scrolled. So if the speed of the tap gesture is fast the cine list is scrolled fast. Whereas if the speed of the tap gesture is less, then the cine list is scrolled slowly. Moreover it may be envisioned that various menu list presented in the user interface 402 can be also reviewed based on tap gestures on the one or more regions in the user interface 402.

Further the image cines are captured by selecting the desired image frames from multiple images captured using the medical imaging device 400. The selection of the image frames is performed in response to tap gestures received at the user interface 402. Any image frame from image cine can be deselected also in response to tap gestures received at the user interface 402. For instance selection of an image frame is performed in response to providing tap gestures at high speed. Whereas the image frame is deselected in response to providing tap gestures at lower speed.

The region of the user interface 402 where the tap gestures are provided may be predefined. So in an embodiment the regions where tap gestures are provided for different image scan parameters may be different. In an alternate embodiment the region for providing the tap gestures can be defined by the user. As described with respect to varying the image scan parameters such as, volume, brightness, zooming and depth associated with medical imaging similarly other image scan parameters such as frequency, gain, scan format, image frame rate, field of view and focal point can be varied by providing appropriate tap gestures on the user interface 402. Further in another embodiment the user may need to view multiple images captured and stored during medical imaging procedure (such as ultrasound imaging done on the patient). These images can be viewed one by one in response to receiving tap gestures on the user interface 402. The tap gestures may be given at any location in the user interface. Based on the rate of the tap gestures the speed at which images are displayed changes. In another embodiment the images may be stored in a particular sequence. The tap gestures in this embodiment can be used to move up and down to review the images in this particular sequence. So similarly multiple functions can be performed by providing tap gestures in any part of a touch based user interface and the rate of tap gestures also determines the function to be performed in a system such as the medical imaging system.

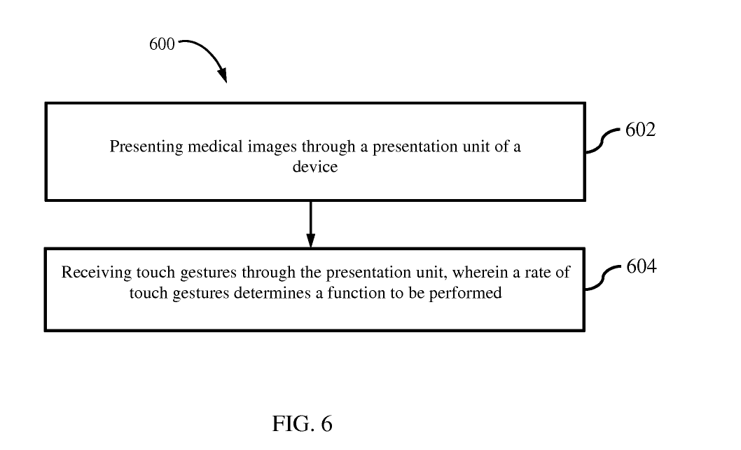

FIG. 6 illustrates a flow diagram of a method 600 for processing touch based inputs according to an embodiment. The touch inputs from a user are received on a touch based user interface i.e. a presentation unit of the device. In an embodiment the device may be an ultrasound imaging device. At block 602, the presentation unit presents multiple images to the user. In case the device is a medical imaging device then the presentation unit may present medical images. Considering an ultrasound application the presentation unit or the display screen of ultrasound imaging device presents ultrasound images associated with a patient. These images are captured and reviewed by a medical expert (doctor or ultrasound technician) to identify a medical condition of the patient.

Thereafter at block 604 touch gestures are received from the user through the presentation unit. The touch gestures may be tapping using user's finger on different locations on the presentation unit for evoking a function to be performed. In an embodiment a rate of touch gestures i.e. tapping gesture determines the function to be performed or vary the function to be performed. The rate of touch gestures may be speed of the tapping using the user's finger. In another embodiment the rate of touch gestures may be number of taps within a unit time for example number of tapping gestures per second. Considering the case of an ultrasound imaging application multiple ultrasound images of the patient may be captured and stored for review. Here the tap gestures may be provided to perform multiple functions associated with ultrasound imaging. In an instance the functions may be associated with image scan parameters. Based on rate of the tap gestures received from the user the image scan parameters can be varied. The image scan parameters in case of the ultrasound imaging application may include but are not limited to, gain, depth, frequency, scan format, image frame rate, field of view and focal point. These image scan parameters can be varied based on the tap gestures i.e. a rate of tap gestures provided on a presentation unit of the ultrasound imaging device. This is explained in detail in conjunction with FIGS. 2, 4 and 5.

From the foregoing, it will appreciate that the above method and system capable of managing touch inputs from a user provides numerous benefits, such as improved way of performing or controlling various functions based on touch gestures at any location in the touch based user interface. Further in a healthcare field, and particularly ultrasound imaging multiple image scan parameters can be controlled using such touch gestures. In the current user interface all the image scan parameters can be configured and varied only by viewing a menu provided and making appropriate selections. All these menu options may pop down also block the medical image that is presented. In another system multiple UI elements such as slide bar option or button clicks may be provided and may be arranged around a window presenting the medical image so the area provided for presenting the images is also less. However the disclosed system enables judicious usage of the area in the user interface and the tap gestures can be provided at a particular region of the user interface which can be predefined and thus no dedicated UI element may be present in the user interface. The region allocated for providing tap gestures can also be used for other purposes such as displaying the medical images. Thus the UI elements used for controlling various functions can be reduced. Further the user can access some functions and vary them in a convenient manner without much time delay accessing some menu option and searching for an appropriate option from the menu.

This written description uses examples to disclose the invention, including the best mode, and also to enable any person skilled in the art to practice the invention, including making and using any computing system or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A system for processing touch based inputs, the system comprising:
a presentation unit capable of receiving touch based inputs; and
a processor for processing touch gestures received on the presentation unit, wherein a rate of touch gestures determines a function to be performed.

2. The system of claim 1, wherein the function comprises varying one or more image scan parameters associated with medical imaging, wherein the presentation unit presents medical images.

3. The system of claim 2, wherein the one or more image scan parameters are associated with performing measurements on a medical image.

4. The system of claim 1, wherein the touch gestures comprise tap gestures by user's finger on the presentation unit.

5. The system of claim 4, wherein the rate of touch gestures comprises speed of the tap gestures, wherein an increase and decrease in speed of the tap gestures varies the function to be performed.

6. The system of claim 4, wherein the tap gestures are received at one or more regions of the presentation unit.

7. The system of claim 6, wherein the one or more regions is at one or more ends of an image area of the presentation unit.

8. The system of claim 4, wherein the rate of touch gestures comprises number of tap gestures, wherein the number of tap gestures varies the function to be performed.

9. A method for processing touch based inputs, the method comprises:
presenting medical images through a presentation unit of a device; and
receiving touch gestures through the presentation unit, wherein a rate of touch gestures determines a function associated with the medical images to be performed.

10. The method of claim 8, wherein the touch gestures comprise one or more tap gestures by user's finger on the presentation unit.

11. The method of claim 9 further comprising varying the one or more image scan parameters in response to change in speed of the one or more tap gestures.

12. The method of claim 9 further comprising varying the one or more image scan parameters based on number of taps gestures on the presentation unit.

13. The method of claim 9, wherein the tap gestures are received at one or more regions of the presentation unit.

14. The method of claim 9, wherein the function comprises varying one or more image scan parameters associated with medical imaging, wherein the presentation unit presents medical images.

15. The method of claim 9, wherein the one or more image scan parameters are associated with performing measurements on a medical image.
